(19) United States
(12) Patent Application Publication
(10) Pub. No.: US 2004/0131523 A1
(43) Pub. Date: Jul. 8, 2004

(54) Oxidation of NOx's with chlorine dioxide in combination with a thermal NOx removal process

(75) Inventors: Theresa J. Takacs, Alexandria, VA (US); Robert G. Balmer, Glen Gardner, NJ (US); Boyd E. Hurst, Humble, TX (US); William J. McLaughlin, Houston, TX (US); David G. Knight, Fairfax, VA (US); John D. Cunic, Denville, NJ (US); Henry Shaw, Scotch Plains, NJ (US); Chen-Lu Yang, Millburn, NJ (US); Pin Gu, Belleville, NJ (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(73) Assignee: ExxonMobil Research and Engineering Company, Annandale, NJ (US)

(21) Appl. No.: 10/427,225

(22) Filed: May 1, 2003

Related U.S. Application Data
(60) Provisional application No. 60/386,560, filed on Jun. 5, 2002.
(60) Provisional application No. 60/386,492, filed on Jun. 5, 2002.
(60) Provisional application No. 60/442,268, filed on Jan. 24, 2003.

(51) Int. Cl. B01D 53/60

(52) U.S. Cl. 423/235

(57) ABSTRACT

A process for reducing NOₓ concentrations in waste gas streams by contacting the waste gas stream with a reducing agent selected from ammonia and urea and then oxidizing the lower NOₓ's present in the waste gas streams to higher oxides with chlorine dioxide.

### CROSS-REFERENCE TO RELATED APPLICATIONS

This application claims benefit of the following United States Provisional Patent Application Serial No. 60/386,560 filed Jun. 5, 2002; Serial No. 60/386,492 filed Jun. 5, 2002; and Serial No. 60/442,268 filed Jan. 24, 2003.

### FIELD OF THE INVENTION

The present invention relates to a process for reducing NOₓ concentrations in waste gas streams. More particularly, the present invention relates to a process for reducing NOₓ concentrations in waste gas streams by contacting the waste gas stream with a reducing agent selected from ammonia and urea. Chlorine dioxide is then mixed with the waste gas streams in a manner such that the chlorine dioxide oxidizes at least a portion of the lower NOₓ's present in the waste gas streams to higher oxides.

### BACKGROUND OF THE INVENTION

Increasingly stringent government regulatory emission standards have forced refiners to explore improved technologies for reducing the concentration of nitrogen oxides (NOₓ) in emissions from combustion and production effluent streams. Various technologies have been developed for reducing nitrogen oxides emissions from combustion and production effluents, such as, for example, U.S. Pat. No. 3,957,949 to Senjo, et al, and U.S. Pat. No. 6,294,139 to Vicard et al., which are both incorporated herein by reference. Further, it is known in the art to reduce NOₓ concentrations in combustion effluent streams by the injection of ammonia, and one such patent utilizing this technology is U.S. Pat. No. 3,900,554 to Lyon, which is incorporated herein by reference. After the Lyon patent, there was a proliferation of patents and publications relating to the injection of ammonia into combustion effluent streams in order to reduce the concentration of NOₓ's. Such patents include U.S. Pat. No. 4,507,269, Dean et al., and U.S. Pat. No. 4,115,515, Tenner et al., which are also incorporated herein by reference. Other patents disclose the use of ammonia injection based on the use of kinetic modeling to determine the amount of ammonia injected. Such patents include U.S. Pat. Nos. 4,636,370, 4,624,840, and 4,682,468, all to Dean et al., and all of which are also incorporated herein by reference. There have also been a number of patents and publications relating to the injection of urea into combustion effluent streams in order to reduce the concentration of NOₓ. One such patent covering this technology is U.S. Pat. No. 4,208,386 to Arand et al., which is incorporated herein by reference. A study by Kim and Lee (1996), incorporated herein by reference, published in the Journal of Chemical Engineering of Japan, “Kinetics of NOx Reduction by Urea Solution in a Pilot Scale Reactor”, Journal of Chemical Engineering of Japan, Vol. 29, No. 4, 1996. pp. 620-626, shows that urea dissociates to ammonia and cyanuric acid (HNCO) and that both of these act as reducing agents for NO in two interrelated chains of free radical reactions.

However, effluents released from combustion units and production streams, such as the regenerator off-gas from a fluidized catalytic cracking process unit remain a source of NOₓ's from refineries. In most refineries, fluidized catalytic cracking process units incorporate wet gas scrubbers to remove attrited catalyst fines that have the added benefit to the refiner of reducing, to a degree, NOₓ emissions because wet gas scrubbers also scrub NO₂ from the fluidized catalytic cracking process unit's waste gas streams. However, the use of these scrubbers is not entirely effective in reducing NOₓ emissions because in existing scrubbed and/or saturated gas systems, such as wet gas scrubbers on combustion units like the fluidized catalytic cracking unit, the off-gasses typically contain NO and NO₂. NO₂ can be removed by scrubbing, but NO cannot. The fact that NO cannot be removed by scrubbing is a problem because the majority of the NOₓ's contained in these wet gas streams is NO. For example, the NOₓ's in the offgas of a fluidized catalytic cracking unit sent to the wet gas scrubber is typically about 90% NO.

Thus, many refiners have experimented and implemented techniques to oxidize NOₓ's to higher oxides, and these techniques have been met with mixed results. Most of the techniques used today involve chemicals that require extended reaction periods, and others create problems within the processing unit. Such problems include, for example, corrosion of materials of construction, problems with treating the waste water of the units, as well as problems with the removal of SOₓ's. For example, it is known in the art to add sodium chlorite (NaClO₂) to the wet gas scrubber liquor to oxidize NOₓ's to higher oxides such as, for example, NO₂ and N₂O₅ which are water soluble and can be removed from the process system, typically as nitrate and nitrite, respectively. The solubility of these higher oxides in water is described by J. B. Joshi, V. V. Mahajani, and V. A. Juvekar in “Invited Review: Absorption of NOx Gases,” Chemical Engineering Communication, Vol. 33 pp 1-92; which is incorporated herein by reference.

However, the addition of NaClO₂ to the scrubber liquor has problems. For example, sodium chlorite is a costly chemical and is consumed by side reactions such as the oxidation of SOₓ's to higher oxides (e.g. SO₂ to SO₃). Thus, because sodium chlorite does not selectively oxidize NOₓ's to higher oxides, conventional methods used high sodium chlorite concentrations in the scrubber liquor to achieve the desired reduction of NOₓ's. These high levels of sodium chlorite lead to high chloride levels which cause, among other problems, corrosion of the scrubber's materials of construction.

Thus, there exists a need in the art to economically remove NOₓ's from waste gas streams.

### SUMMARY OF THE INVENTION

The presently disclosed invention provides a process for removing NOₓ's contained in an SOₓ-containing waste gas stream, which stream contains both lower and higher nitrogen oxides, which process comprises:

a) forming a mixture of a reducing agent selected from ammonia and urea and a readily-oxidizable gas in an effective amount that will reduce the NOₓ concentration of said waste gas stream by a predetermined amount;

b) injecting said mixture into said waste gas stream at a point wherein said SOₓ-containing waste gas stream is at a temperature below about 1600° F.;

c) removing at least a portion of the SOₓ present in said waste gas stream;

d) mixing an effective amount of chlorine dioxide with said waste gas stream at a point downstream from step c) above thereby oxidizing at least a portion of the lower oxide NOₓ's present in said waste gas stream to higher oxides; and

e) removing at least a portion of said higher oxides by a means selected from the group consisting of alkaline solution absorption, reducing solution absorption, scrubbing with water, ammonia injection, and catalytic conversion.

In one embodiment of the present invention, spray nozzles of a wet gas scrubber separator drum are used to mix the chlorine dioxide with the SOₓ-containing waste gas stream.

In another embodiment of the present invention, an effective amount of reducing agent and readily-oxidizable gas are injected into an existing regenerator overhead line at a point upstream of an FCCU's heat recovery device.

In another embodiment of the present invention, an effective amount of reducing agent and readily-oxidizable gas are simultaneously injected into an existing regenerator overhead line at multiple locations upstream of an FCCU's heat recovery device.

In yet another embodiment of the present invention, the readily-oxidizable gas is hydrogen and the reducing agent is ammonia.

### DETAILED DESCRIPTION OF THE PRESENT INVENTION

As used herein, the terms NOₓ's, nitrogen oxides or nitrogen oxide refers to the various oxides of nitrogen that may be present in waste gasses. Thus, the terms refer to all of the various oxides of nitrogen including, but not limited to, nitric oxide (NO), nitrogen dioxide (NO₂), nitrogen peroxide (N₂O₄), nitrogen pentoxide (N₂O₅), and mixtures thereof. However, the term also loosely refers to nitric oxide (NO) since NO typically comprises greater than about 90% of the nitrogen oxides present in combustion waste gasses upon which the presently claimed invention is practiced. Therefore, the presently claimed process is especially concerned with the reduction and control of NO. Also, the terms flue gas, wet gas, combustion waste gas, and waste gas stream are used interchangeably herein to refer to the same scrubbed and/or saturated gas streams. Also, the terms wet gas scrubber, scrubbing apparatus, and scrubber are used interchangeably herein. It should also be noted that “higher oxide” as used herein is meant to refer to any NOₓ wherein “x” is two or greater.

Also, an effective amount of chlorine dioxide, as used herein, is an amount that oxidizes at least a portion, about 10 vol. %, of the NOₓ's present in the waste gas stream, for example about 10 vol. % to about 80 vol. %, preferably about 40 vol. % to about 90 vol. % of the NOₓ's, more preferably about 50 vol. % to about 99 vol. %, and most preferably substantially all of the NOₓ's present in the waste gas stream are oxidized to higher oxides.

It should also be noted that mixing, as used herein when describing the mixing of a reducing agent and a readily-oxidizable gas, is meant to refer to the broadest meaning given the term. Thus, mixing refers to the objective of maximizing the local contact of a reducing agent and a readily-oxidizable gas with the NOₓ in the waste gas stream at the desired molar ratios. Any suitable mixing techniques can be employed to achieve this end. These techniques include, but are not limited to, using a carrier gas with the reducing agent and/or readily-oxidizable gas to encourage more homogenous mixing; injecting a premixed stream of a reducing agent, readily-oxidizable gas and carrier gas into the waste gas stream; or, injecting a stream of reducing agent and carrier gas and a stream of readily-oxidizable gas and carrier gas into the waste gas stream separately. Non-limiting examples of suitable pre-injection mixing techniques, processes or means include piping the reducing agent, readily-oxidizable gas and carrier gas through separate lines into one common vessel or into the injection line to the waste gas stream, allowing the two reagents and the carrier to mix as they flow towards the injection point.

The present invention provides a cost-effective manner whereby refiners can remove NOₓ's from waste gas streams. The oxidation of NOₓ's to higher oxides is an effective way to remove NOₓ's from flue gas streams because the higher nitrogen oxides such as, for example, NO₂ and N₂O₅ are water soluble and can be removed from the system as nitrate or nitrite. Thus, the presently claimed process involves forming a mixture of a reducing agent and readily oxidizable gas in amounts effective at reducing the NOₓ concentration of the waste gas stream by a predetermined amount, removing at least a portion of the SOₓ's present in the stream, and adding an effective amount of chlorine dioxide to the waste gas stream whereby a portion of the NOₓ's contained in the waste gas stream are oxidized to higher oxides (e.g. NO oxidized to NO₂). The higher oxides are then removed by a method selected from alkaline solution absorption, reducing solution absorption, scrubbing ammonia injection, catalytic conversion and absorption with water.

However, the instant invention is especially suited for reducing the concentration of NOₓ's within the process flow scheme of a Fluidized Catalytic Cracking Unit (“FCCU”). Fluidized catalytic cracking is an important and widely used refinery process. The catalytic cracking process typically converts heavy oils into lighter products such as gasoline. In the fluidized catalytic cracking (FCC) process, an inventory of particulate catalyst is continuously cycled between a cracking reactor and a catalyst regenerator. Average reactor temperatures are in the range of about 900-1000° F., with average feed temperatures from about 500-800° F. The reactor and the regenerator together provide the primary components of the catalytic cracking unit. FCC process units are well known in the art and U.S. Pat. No. 5,846,403, Swan, et al., incorporated herein by reference, provides a more detailed discussion of such a unit.

The regenerator is especially important to catalyst life and effectiveness because during the fluidized catalytic cracking process, carbonaceous deposits (coke) are formed on the catalyst, which substantially decrease its activity. The catalyst is then typically regenerated to regain its effectiveness by burning off at least a portion of the coke in the regenerator. This is typically done by injecting air, or another gas having a combustible amount of oxygen, into the regenerator at a rate sufficient to fluidize the spent catalyst particles. A portion of the coke contained on the catalyst particles is combusted in the regenerator, resulting in regenerated catalyst particles. Typical regenerator temperatures range from about 1050° F. to about 1450° F., while exit temperatures of the regenerator off-gas usually range from about 1200° F. to about 1500° F.

After regeneration, the catalyst particles are cycled back to the reactor. The regenerator off-gas is usually passed to further processes such as heat recovery devices, particulate removal devices, carbon monoxide combustion/heat recovery units (COHRU), which, as previously mentioned, are designed to convert CO to CO₂ and recover available fuel energy, and SOₓ removal devices.

In this preferred embodiment of the present invention, the initial NOₓ removal step removes at least a portion of the NOₓ's present in the waste gas stream, thus reducing the amount of chlorine dioxide needed to oxidize the remaining NOₓ's present in the waste gas stream. In this first removal step, a predetermined amount of the NOₓ's is removed from the waste gas stream. This predetermined amount is typically at least about 10 vol. %, preferably more than about 30% by volume, more preferably more than about 50% by volume, and most preferably a reduction of more than about 70% by volume, based on the total volume of NOₓ present in the process stream.

The NOₓ's are removed through the use of an effective amount of a reducing agent selected from urea and ammonia. Preferred is ammonia. An effective amount of reducing agent is to be considered that amount of reducing agent that will reduce the NOₓ concentration by the predetermined amount. An effective amount of reducing agent will typically range from about 0.5-12 moles of reducing agent per mole of NOₓ, preferably about 0.5-8 moles of reducing agent per mole of NOₓ. It is most preferred to use 1-4 moles of reducing agent per mole of NOₓ. It should be noted that the reducing agent is used in conjunction with a readily-oxidizable gas for purposes of this invention.

It is believed that a complex chain of free radical reactions achieves the non-catalytic reduction of NOₓ with the present reducing agent and readily-oxidizable gas. Not wanting to be limited by theory, the inventors herein believe the overall effect can be illustrated by the following two competing reactions:

NO+NH₃+O₂→N₂+H₂O (reduction) Equation 1

NH₃+O₂→NO+H₂O (oxidation) Equation 2

The use of urea as the reducing agent introduces cyanuric acid (HNCO) as well as ammonia to the process. As demonstrated in the work of Lee and Kim (1996), cyanuric acid acts as a reducing agent for NO and also interacts with the NO—NH₃—O₂ chemistry summarized in Equations 1 and 2. Although the cyanuric acid reduction process is not thoroughly understood, and not wishing to be limited by theory, the inventors hereof believe that the dissociation of one mole of urea liberates one mole of ammonia and one mole of cyanuric acid. Experimental data from the Kim and Lee study (1996) suggests that cyanuric acid stoichiometrically reduces NO to elemental nitrogen and water at a molar ratio with NO of 1:1. Thus, urea should generally be used at a molar ratio to NO that is roughly one half the effective molar ratio for ammonia.

The reduction reaction of Equation 1 dominates in the 1600° F.-2000° F. temperature range. Above 2000° F., the reaction of Equation 2 becomes more prevalent. Thus, in the practice of the present invention, it is desirable to operate at temperatures below about 2000° F. However, operating temperatures lower than about 1600° F. are achievable with the reduction reaction still being dominated by Equation 1 through the use of the present invention. The inventors hereof have unexpectedly found that, at temperatures below about 1600° F., the reduction reaction of Equation 1 will not effectively reduce NOₓ without the injection of a readily-oxidizable gas, such as hydrogen. It should be noted that as the temperature of the process stream decreases, the amount of readily-oxidizable gas needed to drive the reduction reaction increases. However, the inventors herein have determined that the molar ratios of readily-oxidizable gas disclosed herein can be used at an effective operating temperature range below about 1600° F., even below about 1300° F., with the reduction reaction still being dominated by Equation 1. This makes the present invention especially suited for reducing NOₓ concentrations in the off-gas of an FCCU regenerator because the temperature of the regenerator off-gas stream is typically low, below about 1600° F. It should be noted, however, that the present invention can also effectively operate over any temperature range between about 1200° F. to about 1600° F.

A readily-oxidizable gas is used to drive the NOₓ reduction reaction. An effective amount of readily-oxidizable gas is that amount that enables the reducing agents of the present invention to effectively reduce the NOₓ concentration by the predetermined amount. A molar ratio of about 1:1 to about 50:1 moles of readily-oxidizable gas per mole of reducing agent is considered an effective amount of readily-oxidizable gas, preferably greater than about 10:1 to about 40:1, more preferably about 11:1 to about 40:1, and most preferably about 15:1 to about 30:1. The actual mole ratio employed will be dependent on such things as the temperature of the waste gas stream; the composition of the waste gas stream; the effectiveness of the injection means used for mixing the readily-oxidizable gas with the carrier gas, the reducing agent and the NOₓ-carrying stream; and the reducing agent utilized. Thus, for a given waste gas stream, the most effective readily-oxidizable gas to reducing agent molar ratio will be in the 1:1 to 50:1 range. The injection of readily-oxidizable gas at rates yielding readily-oxidizable gas to reducing agent molar ratios greater than 10:1 is, in part, made necessary by the low oxygen concentration found in waste gas streams such as the regenerator off-gas. For example, such streams typically contain less than about 1.5% by volume of oxygen.

The reducing agent and readily-oxidizable gas are introduced or conducted into the waste gas stream at a point before at least a portion of the SOₓ's present in the stream are removed. At this point, the waste gas stream flowing from the regenerator to the next piece of equipment, typically a COHRU, has a concentration of greater than about 0.1 vol. % oxygen, based on the volume of the stream. Preferably the process stream contains at least about 0.4, more preferably about 0.4 to about 1.5 vol. %. Thus, this stage of the process is especially well suited for treating the regenerator off-gas of a fluidized catalytic cracking unit. It is preferred that the reducing agent and readily-oxidizable gas be introduced directly into a regenerator overhead line of a fluidized catalytic cracking unit (“FCCU”) before the carbon monoxide combustion/heat recovery unit associated with the FCCU. It is more preferred that the reducing agent and readily-oxidizable gas be introduced directly into the regenerator overhead line as near the outlet from the regenerator as possible. It is also contemplated within this embodiment that the reducing agent and readily-oxidizable gas be simultaneously conducted or introduced into the regenerator overhead line through multiple points located along the regenerator overhead line.

Since the amount of readily-oxidizable gas and reducing agent used are typically a small percentage of the regenerator off-gas flow, typically less than about 0.5% by volume, based on the volume of the stream, it is preferred to use only an effective amount of a readily available and relatively inexpensive carrier material. Non-limiting examples of carrier materials include air and steam; however, any carrier material that does not have a deleterious effect on NOₓ reduction, or which itself contributes to undesirable emissions, can be used. Thus, it is contemplated to mix effective amounts of reducing agent and/or readily-oxidizable gas prior to mixing with a carrier material, or within the line that contains the carrier material. It is preferred that the reducing agent/readily-oxidizable gas mixture be injected into the line that conducts the carrier material.

By an effective amount of carrier material, it is meant an amount of carrier material that will adequately mix the reducing agent and the readily-oxidizable gas with the process stream, i.e., maximize the contact of the two reagents with the NOₓ sought to be reduced.

The regenerator off-gas also typically contains catalyst fines. These catalyst particles may be removed from the regenerator off-gas by any suitable means known in the art. However, the presence of catalyst fines in the regenerator off-gas is believed to assist the NOₓ reduction reaction. Thus, the presence of some catalyst fines, although not necessary for the practice of the instant invention, is preferred to assist the NOₓ reduction reaction and reduce the amount of readily oxidizable gas that is needed.

In a preferred embodiment of the present invention, effective amounts of a reducing agent and a readily-oxidizable gas, preferably with an effective amount of carrier material, are injected directly into the regenerator's existing overhead line. Thus, the existing overhead line functions as the reaction zone for the NOₓ reduction reaction, thereby eliminating the need to add costly processing equipment to effectuate the present process. The injection mixture is preferably injected at a point between the COHRU and the regenerator. It is preferred that the injection occur as near the regenerator off-gas outlet as possible so that the higher temperatures near the regenerator outlet can be utilized, thereby reducing the amount of readily-oxidizable gas needed for a desired level of NOₓ reduction. It is also advantageous to maximize the residence time of the reducing agent and readily-oxidizable gas in the NOₓ reduction reaction.

In another embodiment, at least two, preferably a plurality of, injection points are used along the regenerator overhead line. Effective amounts of a reducing agent and a readily oxidizable gas, preferably with an effective amount of carrier material, are injected through these multiple injection points, which will typically be between the COHRU and the regenerator. Preferably all injections occur simultaneously. Thus, the existing regenerator overhead line again functions as the reaction zone for the NOₓ reduction reaction, thereby eliminating the need to add costly processing equipment to effectuate the present process. Preferably, the simultaneous injections occur as near the regenerator off-gas outlet as possible. However, the multiple injection locations are also preferably spaced such that the appropriate residence time between locations is achieved such that the desired effect from the use of multiple injection locations is realized. As previously mentioned, it is advantageous to maximize the residence time of the reducing agent and readily-oxidizable gas in the overhead line to complete the reaction.

The addition of sodium chlorite to the scrubber liquor is well known and is described in U.S. Pat. No. 6,294,139, which has already been incorporated by reference herein. However, in most cases, the reagent that oxidizes the NOₓ's to higher oxides (e.g. NO to NO₂ and/or N₂O₅) is actually chlorine dioxide, not sodium chlorite. Thus, the sodium chlorite is usually injected into the waste gas stream with an acidic component that is capable of disproportionating the sodium ions and chlorine dioxide.

Chlorine dioxide, after it disproportionates from the sodium chlorite molecule, also oxidizes SOₓ's to higher oxides. This non-preferential oxidation reaction forced refiners to inject relatively high levels of sodium chlorite into the waste gas stream in order to reduce the NOₓ's present in the waste gas stream by a satisfactory amount. As previously discussed, these high levels of sodium chlorite have the undesirable effects of corrosion of process unit hardware, such as scrubbers, problems with waste water treatment and also increased expenditures on reagents.

However, chlorine dioxide, as used in the presently claimed process, is mixed with the waste gas stream at a point after a portion of the SOₓ's present in the waste gas stream are removed. The method by which the SOₓ's are removed is not essential to the present invention and may be any method known in the art. However, the method chosen by the practitioner of the presently claimed invention should reduce the levels of SOₓ's in the waste gas stream to below about 100 ppm, preferably below about 50 ppm, and more preferably below about 10 ppm before the chlorine dioxide is mixed with the waste gas stream. It is most preferred to remove substantially all of the SOₓ's present in the waste gas stream are removed before the chlorine dioxide is mixed with the waste gas stream. Non-limiting examples of SOₓ removal processes suitable for use herein include wet desulfurization methods such as water scrubbing, alkali scrubbing, magnesia scrubbing, and ammonium scrubbing; as well as dry desulfurization methods such as using manganese oxide or activated carbon. Preferably, the SOₓ's are removed by a wet desulfurization method, most preferably by use of a wet gas scrubber.

By mixing the chlorine dioxide with the waste gas stream after the removal of SOₓ's, refiners use amounts of chlorine dioxide only slightly greater than stoichiometric amounts. In general, calculating the stoichiometric amount is complicated because the method by which chlorine dioxide converts NOₓ's to higher oxides is complex. However, while not wanting to be limited by theory, the inventors hereof believe that the general oxidation reaction whereby chlorine dioxide oxidizes NOₓ's can be represented by the following equation:

5NO+3ClO₂+4H₂O→5HNO₃+3HCL Equation 1

Generally, the amount of chlorine dioxide used in the practice of the present invention is about 3 to about 8 moles of ClO₂ to about 5 moles of NO. The refiner can also practice the present invention by using about 4 to about 7 moles of ClO₂ to about 5 moles of NO. The practitioner preferably uses slightly greater than stoichiometric amounts of chlorine dioxide, which is about 3 to about 4 moles of ClO₂ to about 5 moles of NOₓ.

However, in some instances, the caustic contained in the scrubber may neutralize a portion of the HCl in Equation 1. In such instances where the pH of the system is basic, again while not wanting to be limited by theory, the inventors hereof believe that the general oxidation reaction whereby chlorine dioxide oxidizes lower NOₓ's to higher oxides can be represented by the following equation:

4NO+3ClO₂⁻+4OH⁻→5HNO₃+3HCl Equation 2

Thus, in a basic environment, the amount of chlorine dioxide used in the practice of the present invention is about 3 to about 8 moles of ClO₂ to about 4 moles of NO. The refiner can also practice the present invention by using about 4 to about 7 moles of ClO₂ to about 4 moles of NO. Preferably the practitioner uses slightly greater than stoichiometric amounts of chlorine dioxide, about 3 to about 4 moles of ClO₂ to about 4 moles of NOₓ.

After oxidation of the lower NOₓ's to higher nitrogen oxides, at least a portion of the oxidized NOₓ's is removed from the waste gas stream. In the practice of the presently claimed invention, about 20 vol. % to about 100 vol. % of the higher oxides are removed after oxidation, preferably about 40 vol. % to about 80 vol. % of the higher oxides are removed after oxidation, more preferably about 60 vol. % to about 90 vol. % of the higher oxides of the NOₓ's are removed after oxidation.

The removal of at least a portion of the higher oxides is achieved by any known process in the art, except sodium chlorite absorption. These processes include, but are not limited to, the use of an alkaline solution such as an aqueous caustic soda solution or a reducing solution such as an aqueous sodium thiosulfate solution; catalytic conversion, and ammonia and hydrogen injection, as described in U.S. Pat. No. 3,900,554 to Lyon, which has already been incorporated herein by reference. Also, it is well known in the art that oxidized NOₓ compounds such as NO₂ and N₂O₅ are water soluble. The solubility of these higher oxides in water is described by J. B. Joshi, V. V. Mahajani, and V. A. Juvekar in “Invited Review: Absorption of NOx Gases,” Chemical Engineering Communication, Vol. 33 pp 1-92; which is incorporated herein by reference. Thus, another non-limiting example of a NOₓ removal step, and the most preferred embodiment of the present invention, involves absorption of the oxidized NOₓ compounds with water.

As previously discussed, at least a portion of the SOₓ's present in the waste gas stream can be removed by the use of a wet gas scrubber. These scrubbers remove, among other things, attrited catalyst fines and SOₓ's. Thus, in one embodiment of the present invention, the scrubbed and/or saturated gas, sometimes referred to herein as flue gas, is contacted directly with chlorine dioxide (ClO₂) at a point downstream from a wet gas scrubber. By contacting the flue gas after the scrubber, the chlorine dioxide can oxidize an increased amount of NOₓ's because there are lesser amounts of SOₓ's to compete with the oxidation reaction. Further, the low addition rates of ClO₂ that are needed to oxidize the lower NOₓ's to higher oxides assist the refiner in overcoming a majority of the problems, such as, for example, corrosion, wastewater treatment.

In another embodiment of the presently claimed invention, the chlorine dioxide is mixed with the waste gas in the separator drum associated with a wet gas scrubber. A separator drum typically contains hardware such as spray nozzles. In this embodiment, the chlorine dioxide is sprayed through the spray nozzles such that when the contaminated flue gas stream is fed into the wet gas separator drum, it first contacts the chlorine dioxide. The chlorine dioxide can first be mixed with deionized water which acts as a carrier fluid for the chlorine dioxide. Also, additional amounts of deionized water can be sprayed through the spray nozzles. By additional amounts of deionized water, it is meant amounts of deionized water sufficient to absorb at least a portion of the higher oxides.

In another embodiment of the presently claimed invention, a greater amount of chlorine dioxide necessary to oxidize a portion of the NOₓ's present in the waste gas stream is mixed with the waste gas stream after the SOₓ removal step. This additional amount of chlorine dioxide allows the refiner the ability to oxidize any SOₓ's remaining in the waste gas stream after the SOₓ removal step to higher oxides. These higher oxides of SOₓ's can then be removed by any method known in the art.

The above description is directed to several means for carrying out the present invention. Those skilled in the art will recognize that other means which are equally effective could be devised for carrying out the spirit of this invention.

### EXAMPLE

The following example will illustrate the effectiveness of the present process, but is not meant to limit the present invention.

### Example 1

The effect of chlorine dioxide on the oxidation of NOₓ's was tested in a bubble column. Chlorine dioxide was mixed with a simulated scrubber liquor which contained 1002 ppm NOₓ. In this experiment, the simulated scrubber liquor was allowed to flow at a rate of 2 l/min into the bubble column where it was mixed with 1.5 dm³ of a water/chlorine dioxide oxidizing solution containing 107 ppm ClO₂. The temperature of the bubble column during the experiment was monitored using a thermocouple device, and the temperature was observed to be 18° C.

A NOₓ balance was performed on the bubble column by measuring the concentration of nitrogen oxides in the simulated scrubber liquor before and after mixing with the oxidizing solution. The results of this balance are contained in Table 1 below.

TABLE 1

| | | | | Percentage of |
|---|---|---|---|---|
| | | Initial | Final | Total Final |
| | | Concen- | Concen- | Concentration |
| | | tration | tration | in Total Initial |
| Source | Compound | (Moles) | (Moles) | Concentration (%) |
| Gas | NO | 0.0017 | — | |
| Gas | NO2 | 0.0004 | 0.0002 | |
| Aqueous | NO2- | — | — | |
| Aqueous | NO3- | — | 0.0019 | |
| | Total | 0.0021 | 0.0021 | 100% |

1. A process for removing NOₓ's contained in a SOₓ containing waste gas stream, which stream contains both lower and higher nitrogen oxides, which process comprises:
a) forming a mixture of a reducing agent selected from ammonia and urea and a readily-oxidizable gas in an effective amount that will reduce the NOₓ concentration of said waste gas stream by a predetermined amount;
b) injecting said mixture into said waste gas stream at a point wherein said SOₓ-containing waste gas stream is at a temperature below about 1600° F.;
c) removing at least a portion of the SOₓ present in said waste gas stream;
d) mixing an effective amount of chlorine dioxide with said waste gas stream at a point downstream from step c) above, thereby oxidizing at least a portion of the lower oxide NOₓ's present in said waste gas stream to higher oxides; and
e) removing at least a portion of said higher oxides by a means selected from the group consisting of alkaline solution absorption, reducing solution absorption, scrubbing with water, ammonia injection, and catalytic conversion.

2. The process according to claim 1 wherein said waste gas stream is generated by a fluidized catalytic cracking process unit (“FCCU”), said FCCU having a regenerator.

3. The process according to claim 2 wherein said mixture is injected into regenerator off-gas generated by said FCCU.

4. The process of claim 3 wherein said readily-oxidizable gas is selected from the group consisting of paraffinic, olefinic and aromatic hydrocarbons and mixtures thereof, gasoline, fuel oil, oxygenated hydrocarbons, formic and oxalic acids, nitrogenated hydrocarbons, sulfonated hydrocarbons, carbon monoxide, and hydrogen.

5. The process according to claim 4 wherein said readily-oxidizable gas is hydrogen.

6. The process according to claim 5 wherein said reducing agent is ammonia.

7. The process according to claim 6 wherein said reducing agent is injected in a molar ratio of about 0.5 to about 12 moles per mole of NOₓ.

8. The process according to claim 7 wherein said reducing agent is injected in a molar ratio of about 0.5 to about 8 moles per mole of NOₓ.

9. The process according to claim 8 wherein said reducing agent is injected in a molar ratio of about 1 to about 4 moles per mole of NOₓ.

10. The process according to claim 9 wherein said mixture comprises said readily-oxidizable gas and said reducing agent in a molar ratio of about 1:1 to about 50:1 moles of readily-oxidizable gas per mole of reducing agent.

11. The process according to claim 10 wherein said mixture comprises said readily-oxidizable gas and said reducing agent in a molar ratio of about 10:1 to about 40:1 moles of readily-oxidizable gas per mole of reducing agent.

12. The process according to claim 11 wherein said mixture comprises said readily-oxidizable gas and said reducing agent in a molar ratio of about 15:1 to about 30:1 moles of readily-oxidizable gas per mole of reducing agent.

13. The process according to claim 12 wherein said reducing agent and readily-oxidizable gas are injected with a carrier material such as steam or air.

14. The process according to claim 13 wherein catalyst fines from the regenerator are present in the regenerator off-gas.

15. The process according to claim 14 wherein said mixture is injected into said regenerator off-gas at a point between the regenerator and a carbon monoxide combustion/heat recovery unit (COHRU).

16. The process according to claim 15 wherein said mixture is injected into said regenerator off-gas at a point where the regenerator off-gas is at a temperature in the range of about 1200° F. to about 1600° F.

17. The process of claim 1 wherein said predetermined amount is a reduction of NOₓ in said process stream by more than about 30 vol. %.

18. The process according to claim 17 wherein said predetermined amount is a reduction of NOₓ in said process stream by about 90 vol. %.

19. The process according to claim 2 wherein step c) above is carried out by wet desulfurization processes such as water scrubbing, alkali scrubbing, magnesia scrubbing, ammonium scrubbing or dry desulfurization processes such as using manganese oxide or activated carbon.

20. The process according to claim 19 wherein said SOₓ's are removed by wet gas scrubbing.

21. The process according to claim 20 wherein said chlorine dioxide is mixed with said waste gas stream at a point downstream from a wet gas scrubber of a combustion unit.

22. The process according to claim 21 wherein said chlorine dioxide is mixed with said waste gas stream in said wet gas scrubber's separation drum.

23. The process according to claim 22 wherein said chlorine dioxide is mixed with said waste gas stream in said wet gas scrubber's separation drum by using the already existing demister and spray nozzles of said wet gas scrubber separation drum.

24. The process according to claim 23 wherein said chlorine dioxide is mixed with deionized water before mixing with said waste gas stream.

25. The process according to claim 24 wherein an additional amount of deionized water is mixed with said chlorine dioxide wherein said additional amount of deionized water absorbs said higher oxides.

26. The process according to claim 2 wherein said alkaline solution is a liquid such as an aqueous caustic soda solution and said reducing solution is a liquid such as an aqueous sodium thiosulfate solution.
